(19) United States
(12) Patent Application Publication
(10) Pub. No.: US 2007/0089726 A1
(43) Pub. Date: Apr. 26, 2007

(54) Portable cooking grill

(76) Inventor: Harold McNeil, Aliso Viejo, CA (US)

Correspondence Address: DONALD A. KAUL, #19, 189 E. LAKE SHORE DRIVE, CHICAGO, IL, 60611, US

(21) Appl. No.: 11/254,442

(22) Filed: Oct. 20, 2005

(51) Int. Cl. A47J 37/07

(52) U.S. Cl. 126/25 A

(57) ABSTRACT

A portable cooking grill for cooking foods over an outdoor fire is both adjustable and collapsible for ease of transport. The grill includes a perforated food supporting platform which can be adjusted both vertically and horizontally with respect to the ground. The grill is characterized by an upstanding generally vertical ground-engaging rod upon which the perforated food supporting platform is slidably and rotatably mounted. The food supporting platform is formed as an outer frame with transversely extending spaced apart parallel bars. The food supporting platform is attached to a pair of lateral arms which themselves are attached to a sleeve which is slidably supported on the ground-engaging rod. A thumbscrew permits the sleeve to be positioned at any desired vertical height along the ground-engaging rod. The sleeve is also rotatable about the ground-engaging rod, thereby permitting both the height and the lateral position of the food supporting member to be adjusted, as desired. The food supporting member is itself slidably mounted along the lateral arms to permit it to be adjusted horizontally toward and away from the ground-engaging rod, as desired.

### BACKGROUND

This invention relates to portable cooking grills of the type employed to cook foods over an outdoor fire. Persons who engage in camping, hiking, fishing, cycling, and other outdoor recreational activities often have the need or the desire to cook food over an outdoor fire. Such persons need to carry the food grill with them and to be able to use the grill to cook different types of foods.

As a result, the cooking grill for such persons needs to be both lightweight and easily transportable. One way in which this can be accomplished is by making the grill collapsible. Examples of such collapsible grills are shown in U.S. Pat. No. 6,546,851 B1 issued on Apr. 15, 2003 to Osborne and U.S. Pat. No. 4,488,535 issued on Dec. 18, 1984 to Johnson.

It is also desirable in such cooking grills for the food supporting platforms to be adjustable so that the height of the food above the cooking fire can be varied. This feature is also shown in such prior art patents as the aforementioned Johnson patent and in U.S. Pat. No. 4,109,657 issued on Aug. 29, 1978 to Gage et al.

### SUMMARY OF THE INVENTION

The present invention constitutes an improvement over known prior art forms of outdoor cooking grills in that it is very simple to assemble and use; then to disassemble and store for transport. Moreover, the cooking grill of the present invention is both vertically adjustable with respect to the ground to permit the height of the cooking platform to be varied above the cooking fire and horizontally adjustable with respect to the ground to permit the cooking platform to be moved laterally away from the fire.

The improvement of the present invention is accomplished by the combination of a generally vertical ground-engaging rod, a food supporting platform, and supporting means removably attaching the platform to the rod in a manner which permits the platform to be adjusted vertically and horizontally with respect to the rod. The rod is an elongated stake which has a lower end which can be inserted into the ground or into a stand which rests upon the ground. The food supporting platform includes an outer frame and a series of spaced parallel bars extending across the frame. The supporting means includes a sleeve having a central opening through which the rod projects, thereby permitting the sleeve to both slide vertically up and down the rod and also to rotate about the rod. A manually operable thumbscrew enables the sleeve to be positioned at any desired location along the rod. The supporting means also includes laterally extending arm means, preferably a pair of lateral arms which project laterally from the sleeve. The platform is supported on the lateral arms by means of a pair of collars affixed to the underside of the platform, with the arms projecting through the collars. This arrangement enables the platform to be slid along the arms and thereby adjusted horizontally with respect to the rod.

### OBJECTS OF THE INVENTION

It is an object of the present invention to provide a new and improved form of portable cooking grill for cooking foods over an outdoor fire.

Another object of the present invention is to provide a cooking grill which can be quickly and easily assembled and disassembled to permit easy transport.

Another object of the present invention is to provide a portable cooking grill which has a minimum amount of parts to assure that it is lightweight for ease of transport.

Another object of the present invention is to provide a portable cooking grill which enables the food supporting surface to be adjusted vertically with respect to the cooking fire and also to be adjusted horizontally with respect to the cooking fire.

Another object of the present invention is to provide a portable cooking grill in which the food cooking surface is capable of being rotated over and away from the underlying cooking fire.

Other objects, advantages and salient features of the present invention will be apparent from the accompanying drawings which form a part of the disclosure of the preferred embodiment of the invention.

### DESCRIPTION OF THE DRAWINGS

FIG. 1 is a side elevational view of a portable cooking grill in accordance with the present invention;

FIG. 2 is a fragmentary view of an alternative way of affixing the cooking grill into the ground;

FIG. 3 is a top plan view of the present invention employing one form of food supporting platform; and

FIG. 4 is a top plan view of the present invention employing an alternative form of cooking platform.

### DETAILED DESCRIPTION OF THE INVENTION

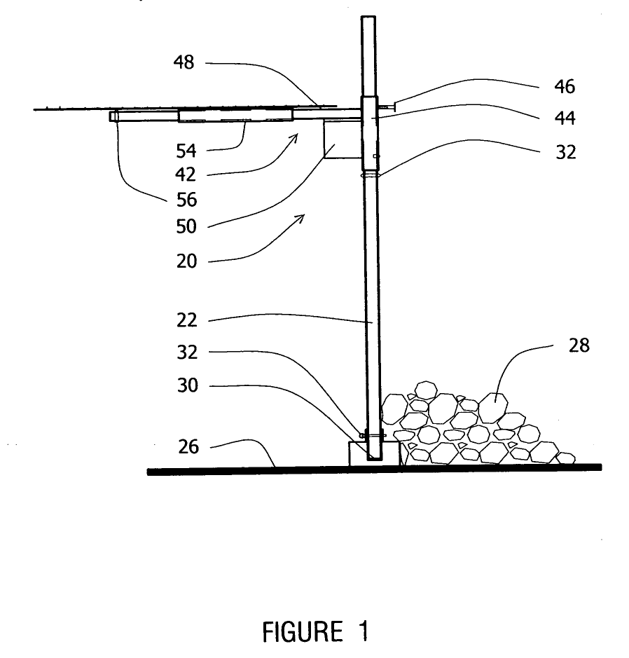

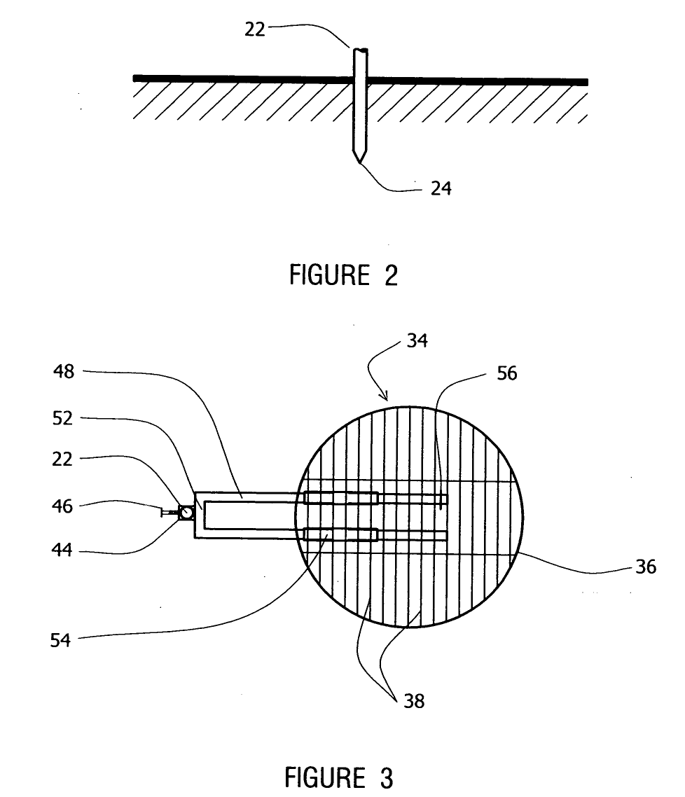

Referring to the drawings, there is shown in FIG. 1 a portable cooking grill generally designated 20 in accordance with the principles of the present invention. The grill 20 includes an elongated rigid rod or stake 22, preferably fabricated of metal, whose lower end may be pointed as shown at 24 in FIG. 2. Such a point enables the rod to be driven into the ground, such as by tapping the upper end with a rock or a hammer, if available. The length of the rod 22 is such that it can be driven deeper into the ground, if, for example, it is to be used in sand on a beach. Alternatively, the lower end of the rod 22 can be supported in an opening in a ground stand 26 having a flat base which rests upon the ground. A series of rocks 28 can be piled on the stand 26 to keep it in position. Advantageously, the stand can include an upstanding tube 30 into which the lower end of the rod 22 fits. As can be seen, the rod is generally vertical with respect to the ground. Of course, in use the rod may not be in an exact vertical position, but it is generally vertical and in a position which is upstanding with respect to the ground.

The rod 22 can include a series of holes, not shown, spaced along its length, to accommodate positioning pins 32 which can pass transversely through such holes. One such positioning pin 32, as shown in FIG. 1, can pass through corresponding holes formed in the tube 30, thereby removably affixing the rod 22 into the stand.

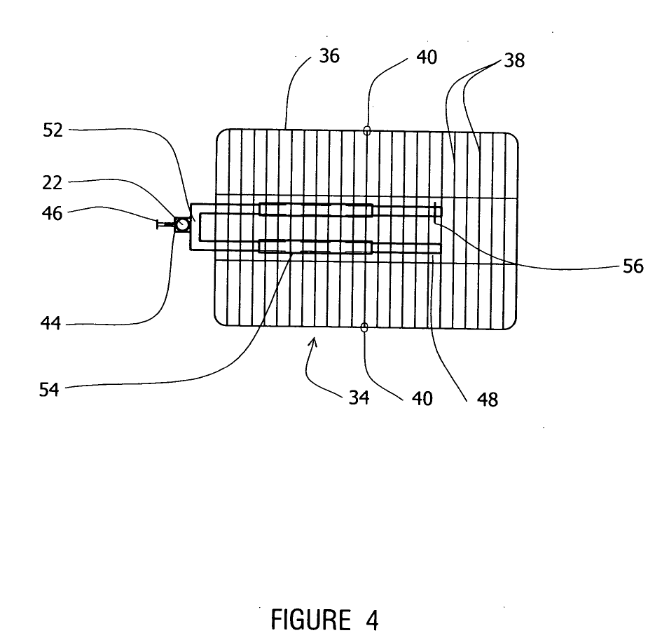

The grill 20 further includes a food supporting platform generally designated 34 upon which the food to be cooked is laid. Two alternative forms of platforms are shown in FIGS. 3 and 4. The platform 34 includes an outer frame 36 which is circular in FIG. 3 and rectangular in FIG. 4. A series of spaced transverse bars 38 extend across the frame 36 thereby forming a perforated cooking surface through which heat and flame can pass. The rectangular frame 36 includes a pair of center hinges 40 which enable the frame to be folded over and back onto itself, thereby minimizing the size during transport.

As can be seen, in use the platform 34 is in a generally horizontal position, spaced above the ground and thus above any cooking fire created on the ground.

The grill 20 also includes supporting means generally designated 42 for removably attaching the platform 34 to the rod 22. The supporting means 42 includes a sleeve 44 which has a central opening therein through which the rod 22 passes. As a result, the sleeve 44 can be slid or moved vertically up and down along the rod 22. Also, the sleeve can be rotated about the sleeve at any vertical position above the ground. A thumbscrew 46 extends through the sleeve 44 to enable the sleeve to be manually locked in any position along the sleeve, including both any vertical position and any rotational position.

A positioning pin 32 can also be used beneath the sleeve 44, as shown in FIG. 1, to assure that the platform 34 will not inadvertently drop onto the ground even if the thumbscrew 46 should accidentally loosen.

The supporting means 42 includes laterally extending arm means in the form of a pair of parallel arm members 48 which are affixed to a support gusset 50 attached to a side of the sleeve 44. The arm members 48 are formed as a narrow “U” shape, with a short interconnecting cross-arm 52 connecting the two arm members 48 to each other and to the gusset 50.

A pair of collars 54 are mounted on the underside of the platform 34, such as by welding the same to the transverse bars 38. The collars 54 are spaced apart the same distance as the arm members 48 and the arm members pass through the collars 54, thereby affixing the platform onto the arm members. However, the platform may be slid or adjusted in and out along the arm members 48, by sliding the collars 54 along the arm members 48, thereby enabling horizontal movement of the platform relative to the ground. At least one stop member 56 is attached at the end of an arm member 48 to prevent the platform from being inadvertently slid off the arm members. The stop member 56 is removable from the arm member or members 48 to enable the platform to be disassembled when no longer in use.

Prior to use, such as when the grill is being transported, the parts are disassembled and collapsed. The rod 22, the stand 26, the supporting means 42, and the platform 34 are all separated and carried in a bag or pouch. To set up the grill for use, the user first either drives the rod 22 into the ground, as shown in FIG. 2, or places the stand 26 firmly in place, as by use of rocks 28, and then inserts the rod into the stand. Next the sleeve 22 is slid upon and attached in a preliminary manner to the rod 22. Then the platform 34 is mounted onto the arm members 48 by sliding the collars 54 onto the arm members. The stop member 56 is attached. Finally, if positioning pins 32 are used, they are likewise put into use.

To use the grill in a cooking operation, the user starts his or her fire at a short distance away from the bottom of the rod 22. The user adjusts the height of the platform 34 along the rod 22 to whatever height above the fire is desired. The user then tightens the thumbscrew 46 with the platform 34 spaced at the desired vertical distance above the fire. The positioning pin 32 can be moved, as necessary. The food carried on the platform is then cooked by the heat and flames from the cooking fire.

When the user wants to remove the food from over the fire, either because it is fully cooked or because he or she wants to check on the status of the cooking, the platform 34 is slid horizontally outward along the arm members 48 to remove the food from the direct effect of the cooking fire. Alternatively, the thumbscrew 46 is loosened and the entire platform 34 and supporting means 42 is rotated around the rod 22 so that the platform is swung horizontally away from over the cooking fire.

After reading the foregoing detailed description, it will be apparent that the objects set forth at the outset hereof have been successfully achieved. The preferred embodiment of the present invention is defined in the appended claims.

I claim:

1. A portable and collapsible cooking grill for cooking foods over an outdoor fire, said grill comprising:
a generally horizontal food supporting platform;
a generally vertical ground-engaging rod, the lower end of which is supported in or on the ground;
supporting means attaching said platform to said rod;
said supporting means enabling said platform to be selectively rotated upon said rod within a horizontal plane;
said supporting means further enabling said platform to be adjusted vertically along said rod.

2. A grill as defined in claim 1 wherein said supporting means includes a sleeve having a central aperture through which said rod projects, thereby enabling said sleeve to be slidable along said rod and rotatable about said rod.

3. A grill as defined in claim 2 wherein said supporting means further includes a manually operable tightening means to fix the position of the sleeve at any desired position along said rod.

4. A grill as defined in claim 3 wherein said manually operable tightening means is a thumbscrew.

5. A grill as defined in claim 3 wherein said supporting means further includes laterally extending arm means attached to said sleeve.

6. A grill as defined in claim 5 wherein said platform is slidably mounted upon said laterally extending arm means, thereby permitting said platform to be adjusted horizontally with respect to said sleeve and rod.

7. A grill as defined in claim 6 wherein said laterally extending arm means includes a pair of spaced arm members.

8. A grill as defined in claim 8 wherein said platform includes a pair of collars mounted on its underside, said collars receiving and being slidable along said arm members.

9. A grill as defined in claim 8 wherein said arm members include at least one stop element adjacent the end remote from said sleeve to prevent the platform from inadvertently being slid off the arm members.

10. A grill as defined in claim 9 further including a ground stand having an opening therein for receiving the lower end of said rod.

11. A grill as defined in claim 1 wherein the food supporting platform includes an outer frame and a series of spaced parallel bars extending across the outer frame.

12. A grill as defined in claim 11 in which the outer frame is circular in configuration.

13. A grill as defined in claim 11 in which the outer frame is rectangular in configuration.

14. A portable and collapsible cooking grill for cooking foods over an outdoor fire, said grill comprising:
a generally horizontal food supporting platform;
a generally vertical ground-engaging rod, the lower end of which is supported in or on the ground;
supporting means removably attaching said platform to said rod;
said supporting means enabling said platform to be adjusted both vertically along said rod and horizontally with respect to said rod.

15. A grill as defined in claim 14 wherein said supporting means includes a sleeve having a central aperture through which said rod projects, thereby enabling said sleeve to be slidable along said rod and rotatable about said rod.

16. A grill as defined in claim 15 wherein said supporting means further includes a manually operable tightening means to fix the position of the sleeve at any desired position along said rod.

17. A grill as defined in claim 16 wherein said manually operable tightening means is a thumbscrew.

18. A grill as defined in claim 16 wherein said supporting means further includes laterally extending arm means attached to said sleeve.

19. A grill as defined in claim 18 wherein said platform is slidably mounted upon said laterally extending arm means, thereby permitting said platform to be adjusted horizontally with respect to said sleeve and rod.

20. A grill as defined in claim 19 wherein said laterally extending arm means includes a pair of spaced arm members.

21. A grill as defined in claim 20 wherein said platform includes a pair of collars mounted on its underside, said collars receiving and being slidable along said arm members.

22. A grill as defined in claim 21 wherein said arm members include at least one stop element adjacent the end remote from said sleeve to prevent the platform from inadvertently being slid off the arm members.

23. A grill as defined in claim 22 further including a ground stand having an opening therein for receiving the lower end of said rod.

24. A grill as defined in claim 14 wherein the food supporting platform includes an outer frame and a series of spaced parallel bars extending across the outer frame.

25. A grill as defined in claim 24 in which the outer frame is circular in configuration.

26. A grill as defined in claim 24 in which the outer frame is rectangular in configuration.

27. A grill as defined in claim 24 wherein the platform further includes hinges in the outer frame to enable the frame, and hence the platform, to be folded over upon itself.

28. A portable and collapsible cooking grill for cooking foods over an outdoor fire, said grill comprising:
a food supporting platform;
an axially elongated ground-engaging rod; and
supporting means coupling said platform to said rod;
said supporting means enabling said platform to be moved, and thereby adjusted, (a) rotatably about said rod, (b) axially along said rod; and
(c) transversely relative to said rod.

29. A grill as defined in claim 28 wherein said supporting means includes a sleeve having a central aperture therein through which said rod projects, said sleeve being connected with said platform.

30. A grill as defined in claim 29 wherein said platform is perforated to enable heat from said fire to cook food placed upon said platform.
